(19) United States
(12) Patent Application Publication
(10) Pub. No.: US 2013/0332888 A1
(43) Pub. Date: Dec. 12, 2013

(54) METHOD AND DEVICE FOR OPERATING LIST IN HANDHELD DEVICE

(71) Applicant: TENCENT TECHNOLOGY (SHENZHEN) COMPANY LIMITED, Shenzhen (CN)

(72) Inventors: Jian DU, Shenzhen (CN); Dan SONG, Shenzhen (CN); Ge GAO, Shenzhen (CN)

(73) Assignee: TENCENT TECHNOLOGY (SHENZHEN) COMPANY LIMITED, Shenzhen (CN)

(21) Appl. No.: 13/967,377

(22) Filed: Aug. 15, 2013

Related U.S. Application Data
(63) Continuation of application No. PCT/CN2012/070891, filed on Feb. 6, 2012.

(30) Foreign Application Priority Data
Mar. 8, 2011 (CN) 01110054561.6

(51) Int. Cl. G06F 3/0488

(52) U.S. Cl. CPC G06F 3/0488
USPC 715/841

(57) ABSTRACT

Disclosed are methods and devices for operating a list in a handheld device. An exemplary method can be provided by first monitoring a list and acquiring list touch initial information and then determining whether the acquired list touch initial information is multi-area touch information. When the acquired list touch initial information is determined to be the multi-area touch information, list touch final information can be acquired and stored. Based on the acquired list touch initial information and the list touch final information, whether a list operation is an expansion operation or a contraction operation is then determined. The list is expanded, when the expansion operation is determined. The list is collapsed, when the contraction operation is determined. The disclosed methods and devices can improve using experiences for users and improve use performance of the handheld device.

### CROSS-REFERENCES TO RELATED APPLICATIONS

This application claims the priority to International Application No. PCT/CN2012/070891, filed on Feb. 6, 2012, which claims priority to Chinese Patent Application No. CN 201110054561.6, filed on Mar. 8, 2011, the entire contents of all of which are incorporated herein by reference.

### FIELD OF THE DISCLOSURE

The present disclosure relates to the field of computer technology and, more particularly, relates to a method and device for operating a list in a handheld device.

### BACKGROUND

A touchscreen of a conventional handheld device, such as a mobile phone, a laptop, and a personal digital assistant (PDA), is usually a resistive touchscreen that supports a simple point-touch operation. Based on the recognized user one-click information, a corresponding operation is executed. For example, for common list operations, a single-click, double-click, or menu selection can be used to expand or to collapse a list. For example, for a file manager list in a handheld device such as a Windows mobile phone, a single-click or double-click can be used to operate, i.e., to expand (e.g., open) or collapse a particular folder or document in the file manager list. For a Windows 7 file manager list in a handheld device, a single-click, double-click, or menu selection can be used to expand the list and select a folder. For a document list in a handheld device such as a Nokia Symbian cell phone, a single-click, or menu selection can be used to expand the list. For Taobao Ali Wangwang software installed in a handheld device and for buddy group lists therein, a single-click can be used to expand a corresponding list.

With development of touchscreen technologies, in order to achieve richer characteristics for human-machine interactions for more intuitive operations and to enhance users' using experiences, a capacitive touchscreen that supports area-touch sensing has been developed. The capacitive touchscreen supports multi-point touch and introduces an area-touch operation in addition to a point-touch operation that is supported in the resistive touchscreen. The capacitive touchscreen further allows user operations to be simplified via area-touch (e.g., multi-point touch) operations using users' fingers, and therefore, introduces input methods for a handheld device and using experience for users. For example, for the above-described list operations, a single-touch can be used to select a document or a folder in a list, and two consecutive operations within a predetermined period of time with respect to a same list can be used to achieve an operation with respect to a folder (e.g., to open a document or a folder).

As such, current methods, for operating a list in a handheld device on a touchscreen that supports area-touch sensing, still use simple single-touch or double-touch to perform list operations. The operation process is not direct and intuitive and cannot meet users' growing demands for personalized using experiences. Further, features and capabilities of the capacitive touchscreen are not effectively utilized.

### BRIEF SUMMARY OF THE DISCLOSURE

The disclosure provides methods and devices for operating a list in a handheld device to improve using experiences for users and use performance of the handheld device.

According to various embodiments, there is provided a method for operating a list in a handheld device by first monitoring a list and acquiring list touch initial information, and then determining whether the acquired list touch initial information is multi-area touch information. When the acquired list touch initial information is determined to be the multi-area touch information, list touch final information can be acquired and stored. Based on the acquired list touch initial information and the list touch final information, whether a list operation is an expansion operation or a contraction operation is then determined. When the expansion operation is determined, the list is then expanded. When the contraction operation is determined, the list is then collapsed.

According to various embodiments, there is also provided a device for operating a list in a handheld device. The device can include a list touch information acquisition module, a list touch information processing module, and a list processing module. The list touch information acquisition module is configured to acquire list touch initial information and list touch final information of a list on a user operating touchscreen, and to output to the list touch information processing module. The list touch information processing module is configured to determine whether the received list touch initial information is multi-area touch information, and to sequentially output the list touch initial information and the list touch final information to the list processing module, when the received list touch initial information is determined to be the multi-area touch information. The list processing module is configured, based on the received list touch initial information and the list touch final information, to determine whether a list operation is an expansion operation or a contraction operation, and to expand the list for the expansion operation or to collapse the list for the contraction operation.

In this manner, by using a multi-point touch input method and the characteristics of a capacitive touchscreen that supports multi-area touch, motion status of the two fingers after touching the capacitive touchscreen can be determined. When the motion of the two fingers is in an expanding state, the list is expanded (e.g., opened); and when the motion of the two fingers is in a contracting state, the list is then collapsed (e.g., folded). This can allow the operation process to be intuitively reflected via the motion of the two fingers. This can meet users' needs for personalized using experiences, achieve direct and intuitive list operations using a handheld device that supports multi-area touch, and improve use performance of the handheld device.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples according to the disclosed embodiments.

FIG. 1 is a schematic process flow diagram of an exemplary method for operating a list in a handheld device in accordance with various disclosed embodiments;

FIG. 2 is a specific schematic diagram of another exemplary method for operating a list in a handheld device in accordance with various disclosed embodiments; and

FIG. 3 is a schematic structural diagram of a device for operating a list in a handheld device in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

As disclosed herein, characteristics (or features) of a capacitive touchscreen that supports multi-area touch can be employed to improve use performance of a handheld device. A multi-area touch such as a two-finger touch can be used to perform a list operation. When the two-finger touch is in a gradually-expanding state, the list can be triggered to perform an expanding operation, and when the two-finger touch is in a gradually-contracting state, the list can be triggered to execute a collapsing operation. This can make the operation process directly and intuitively performed and meet users' demands for personalized using experiences. Thereby, a directly and intuitively performed list operation can be achieved by using the multi-area touch on the handheld device.

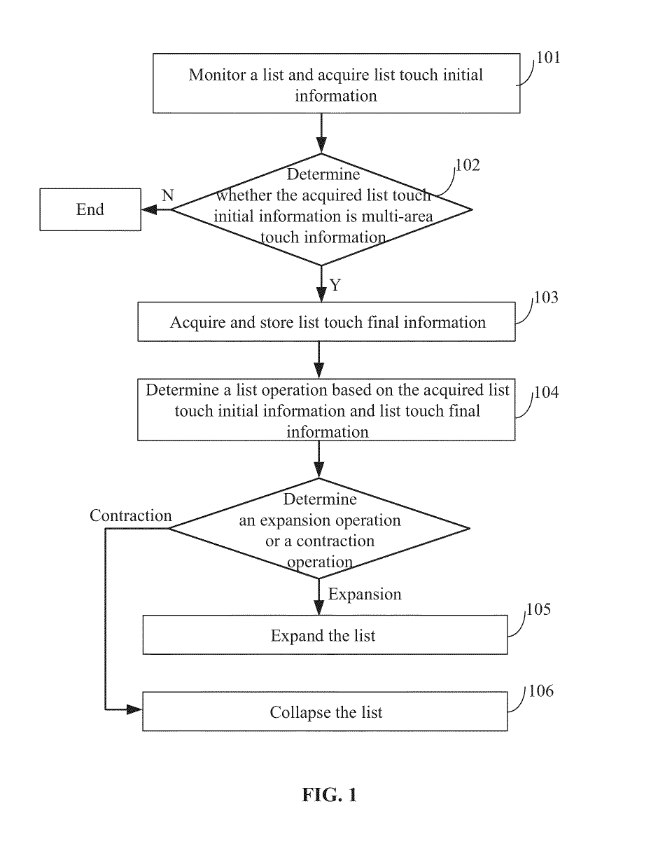

FIG. 1 is a schematic process flow diagram of an exemplary method for operating a list in a handheld device according to various disclosed embodiments.

In Step 101, a list is monitored and list touch initial information is acquired. For example, the list touch initial information may be information of the list on a touchscreen that supports area-touch sensing and that is pressed by a finger of a user; or may be information of the list on the touchscreen that supports area-touch sensing and that is pressed by a touch pen.

As used herein, “one touch” refers to a complete operation from touching down a finger on the touchscreen that supports area-touch sensing to lifting the finger off from the touchscreen that supports area-touch sensing. Corresponding list touch information can include the list touch initial information and list touch final information. Of course, in practice, during a touch process, the list touch information (e.g., the list touch initial information and list touch final information) is not limited to the above-mentioned information and may change along a sliding on the touchscreen, e.g., by the finger.

In Step 102, whether the acquired list touch initial information is multi-area touch information is determined. When the acquired list touch initial information is the multi-area touch information, the method then performs Step 103. Otherwise, when the acquired list touch initial information is not multi-area touch information, the method is then terminated.

The handheld device can determine the number of touch areas contained in the acquired list touch initial information. When the number of the touch areas is one, the handheld device can determine that the acquired list touch initial information is not multi-area touch information. In one embodiment, when the list touch initial information is not multi-area touch information, the method can be performed according to conventional technologies, which are encompassed according to various embodiments. When the number of the touch areas is greater than one, the handheld device can determine that the acquired list touch initial information is multi-area touch information.

As described above, a handheld device that supports multi-point touch may use area-touch sensing. When an area formed by a multi-point touch is within a pre-set touch area range, the area formed by the multi-point touch can be considered as a touch area. Information about determining whether an area formed by a multi-point touch is a touch area can be found in the art and can be encompassed according to various embodiments.

To reduce misuse by a user due to any possible reasons, after the acquired list touch initial information is determined to be the multi-area touch information, the triggered multi-area touch information may be timed, e.g., by a timer. When the timed time exceeds a pre-set time threshold for long-pressing and/or no changes occur to the multi-area touch information (or changes of a touch area corresponding to the multi-area touch information is within a pre-set change range), meaning that the user has been long-pressing the touchscreen during a time period within the pre-set time threshold for long-pressing, the method may then perform Step 103. Otherwise, such operation can be considered as a misuse by the user to terminate the method. Further, the time information of the multi-area touch information generated by user touching the capacitive touchscreen can be simultaneously stored.

In Step 103, list touch final information is acquired and stored. After the list touch initial information is determined to be the multi-area touch information, the next step is to monitor an operation that the user lifts two fingers off from the touchscreen. When it is monitored that the user's two fingers are lifted off from the touchscreen that supports area-touch sensing, touch information at the time when the fingers are lifted off from the touchscreen can be acquired. This type of touch information is referred to as the list touch final information.

In practice, an update period can be pre-set for the touch information. According to the update period of the touch information, the list touch final information in the list touch information can be acquired and respectively recorded.

In Step 104, based on the acquired list touch initial information and list touch final information, whether the list operation is an expansion operation or a contraction operation is determined. When the expansion operation is determined, the method performs Step 105. When the contraction operation is determined, the method performs Step 106.

For example, the multi-area touch information includes touch initial information of a first touch area and touch initial information of a second touch area, which includes initial position information of the two fingers on the touchscreen. The initial position information of one of the two fingers on the touchscreen is referred to as the initial information of the first touch area, and the initial position information of the other finger on the touchscreen is referred to as the initial information of the second touch area.

The handheld device can calculate the initial touch position of the first touch area based on the acquired touch initial information of the first touch area, and the initial touch position of the second touch area based on the acquired touch initial information of the second touch area. For example, the handheld device can calculate information about parameters of center coordinates of the initial touch position of the first touch area and the initial touch position of the second touch area. Any suitable methods for calculating a position of a touch area can be included herein in accordance with various embodiments.

Accordingly, the acquired list touch final information can include the touch final information of the first touch area and the touch final information of the second touch area. A final touch position of the first touch area and a final touch position of the second touch area can be respectively calculated. The initial touch position of the first touch area and the final touch position of the first touch area correspond to sliding of one of the two fingers on the first touch area. The initial touch position of the second touch area and the final touch position of the second touch area correspond to sliding of the other finger on the second touch area.

In various embodiments, whether the list operation is an expansion operation or a contraction operation can determined. For example, when a distance between the initial touch position of the first touch area and the initial touch position of the second touch area is greater than a distance between the final touch position of the first touch area and the final touch position of the second touch area, the list operation is determined to be a contraction operation.

On the other hand, when the distance between the initial touch position of the first touch area and the initial touch position of the second touch area is less than the distance between the final touch position of the first touch area and the final touch position of the second touch area, the list operation is determined to be an expansion operation.

Of course, in practice, whether the list operation is an expansion operation or a contraction operation can also be determined using other suitable methods. For example, when the first touch area is a thumb touch area and the second touch area is an index finger touch area, whether the list operation is an expansion operation or a contraction operation can be determined. For example, when a distance between the initial touch position of the first touch area and the final touch position of the first touch area is greater than a distance between the initial touch position of the second touch area and the final touch position of the second touch area, the list operation is determined to be a contraction operation.

On the other hand, when the distance between the initial touch position of the first touch area and the final touch position of the first touch area is less than the distance between the initial touch position of the second touch area and the final touch position of the second touch area, the list operation is determined to be an expansion operation.

In various embodiments, in a process where a user operates a list, the position of the thumb touch area can maintain unchanged, and a relative displacement between the thumb and the index finger is determined by the sliding of the index finger on the touch area. In this case, whether the list operation is an expansion operation or a contraction operation can also be determined. For example, when a difference between a horizontal axis coordinate value of the initial touch position of the second touch area and a horizontal axis coordinate value of the final touch position of the second touch area is greater than zero, the list operation is determined to be a contraction operation.

On the other hand, when the difference between the horizontal axis coordinate value of the initial touch position of the second touch area and the horizontal axis coordinate value of the final touch position of the second touch area is less than zero, the list operation determined to be an expansion operation.

In some cases when the list operation is determined to be neither an expansion operation nor a contraction operation, conventional technologies can be used. As described above, when time information is stored, the disclosed method further includes determining whether a time difference between a corresponding time of the list touch final information and a corresponding time of the list touch initial information is greater than a pre-set time difference threshold. When the time difference is not greater than the time difference threshold, the method returns to perform Step 103. Otherwise, when the time difference is greater than the time difference threshold, the stored information can be deleted.

In Step 105, expanding the list is performed. In Step 106, collapsing (or folding) the list is performed. In various embodiments, an animation effect may further be added to Steps 105 and/or 106 of the method to expand and/or collapse the list to more vividly visualize the list operation.

In practice, after expanding or collapsing the list, in order to effectively reduce the space for storing the list touch information, the method can further include: deleting the stored list touch initial information and the list touch final information.

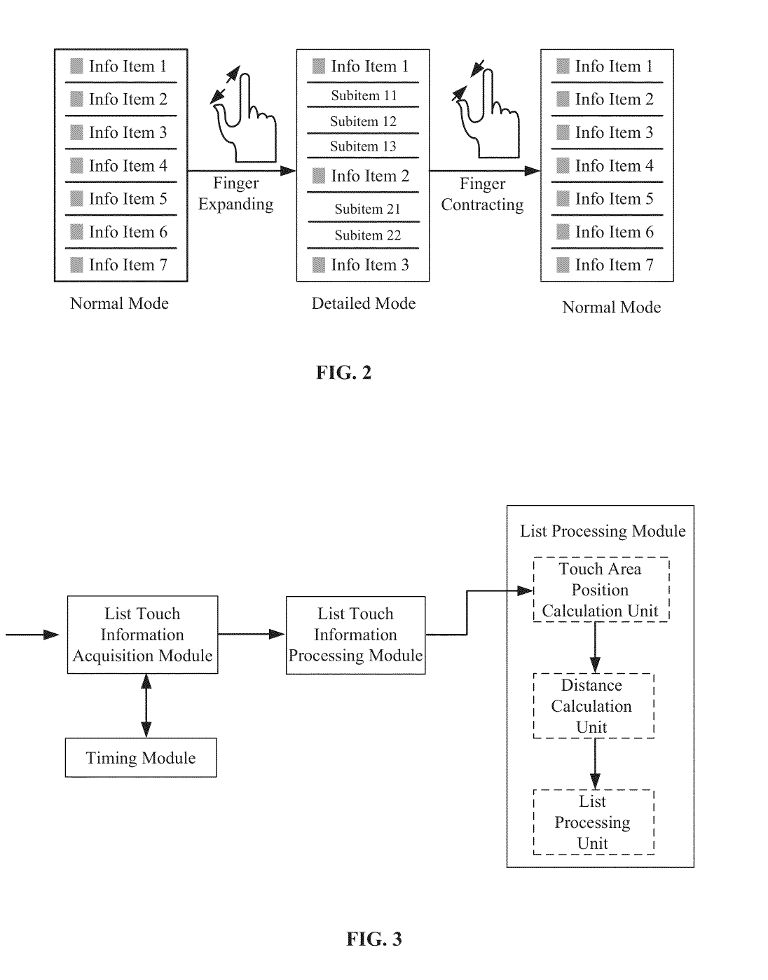

FIG. 2 is a specific schematic diagram of another method for operating a list in a handheld device according to various embodiments. Referring to FIG. 2, in a normal mode, a list is in a collapsed (e.g., folded) state, containing information (or info) items 1-7. A visually direct two-finger expanding gesture (e.g., may be accompanied with animation) can be used to complete an expansion operation of the information items on the grouped list to expand the list into a detailed mode. For example, as shown in FIG. 2, sub-items 11-13, and sub-items 21-22 are expanded. A two-finger contraction gesture can be used to complete a contraction operation of the information items on the grouped list to collapse the list back to the normal mode.

In this manner, the disclosed methods for operating a list in a handheld device includes the following operations: monitoring a list and acquiring list touch initial information; determining whether the acquired list touch initial information is multi-area touch information and, when the acquired list touch initial information is determined to be multi-area touch information, acquiring and storing list touch final information; determining, based on the acquired list touch initial information and list touch final information, whether the list operation is an expansion operation or a contraction operation; and expanding the list when the expansion operation is determined, or collapsing the list when the contraction operation is determined.

As disclosed herein, by using a multi-point touch input method and the characteristics of a capacitive touchscreen that supports multi-area touch, motion status of the two fingers after touching the capacitive touchscreen is determined. When the motion of the two fingers is in an expanding state, the list is expanded; and when the motion of the two fingers is in a contracting state, the list is then collapsed. This can allow the operation process to be directly and intuitively reflected via the motion of the two fingers. This can meet users' needs for personalized using experiences, achieve direct and intuitive list operations using a handheld device that supports multi-area touch, and improve use performance of the handheld device.

FIG. 3 is a schematic structural diagram of a device for operating a list in a handheld device according to various disclosed embodiments. Referring to FIG. 3, the device can include a list touch information acquisition module, a list touch information processing module, and/or a list processing module.

The list touch information acquisition module can be used to acquire list touch initial information and list touch final information of the list on a user operating touchscreen, and to output the acquired information to the list touch information processing module.

In one embodiment, operations for a user to operate list on a touchscreen can include an operation of pressing down on the touchscreen, an operation of sliding along the touchscreen, and/or an operation of lifting fingers off from the touchscreen. In various embodiments, the operation of pressing down on the touchscreen corresponds to the list touch initial information, and the operation of sliding along the touchscreen or the operation of lifting fingers off from the touchscreen corresponds to the list touch final information.

The list touch information processing module can be used to determine whether the received list touch initial information is multi-area touch information, and to sequentially output the list touch initial information and the list touch final information to the list processing module, when the received list touch initial information is determined to be the multi-area touch information.

The list processing module can be used to determine, based on the received list touch initial information and list touch final information, whether the list operation is an expansion operation or a contraction operation, and to expand the list for the expansion operation and to collapse the list for the contraction operation.

In various embodiments, the list processing module can include a touch area position calculation unit, a distance calculation unit, and/or a list processing unit.

The touch area position calculation unit can be used to respectively calculate, the initial touch position information of the first touch area and the initial touch position information of the second touch area, based on the received list touch initial information; and to respectively calculate the final touch position information of the first touch area and the final touch position information of the second touch area, based on the received list touch final information; and to output the calculated information to the distance calculation unit.

The distance calculation unit can be used to calculate an initial relative distance between the initial touch position of the first touch area and the initial touch position of the second touch area, based on the initial touch position information of the first touch area and the initial touch position information of the second touch area; and to calculate a final relative distance between the final touch position of the first touch area and the final touch position of the second touch area, based on the final touch position information of the first touch area and the final touch position information of the second touch area; and to output the calculated results to the list processing unit.

The list processing unit can be used to collapse the list when the initial relative distance is greater than the final relative distance and to expand the list when the initial relative distance is less than the final relative distance.

Optionally, the device for operating a list in the handheld device can also include a timing module. The timing module can be used to perform timing after receiving from the list touch information acquisition module a notification about the acquisition of the list touch initial information; and to notify the list touch information acquisition module to acquire the list touch final information of the list on the user operating touchscreen, when the pre-set touch information update period arrives and when it is monitored that the user's fingers are not lifted off from the touchscreen.

In various embodiments, the disclosed modules can be configured in one device or configured in multiple devices as desired. The modules disclosed herein can be integrated in one module or in multiple modules. Each of the modules disclosed herein can be divided into one or more sub-modules, which can be recombined in any manner.

The disclosed embodiments (e.g., as shown in FIGS. 1-3) can be examples only. One of ordinary skill in the art would appreciate that suitable software and/or hardware (e.g., a universal hardware platform) may be included and used to predict, manage, and execute the disclosed schemes. For example, the disclosed embodiments can be implemented by hardware only, which alternatively can be implemented by software products only. The software products can be stored in a storage medium. The software products can include suitable commands to enable a terminal device (e.g., including a mobile phone, a personal computer, a server, or a network device, etc.) to implement the disclosed embodiments.

In various embodiments, the handheld device and/or the device for operating the list in the handheld device may be implemented on any appropriate computing platform. For example, such computing platform can be a computer system including a processor, a storage medium, a monitor, a communication module, a database, peripherals, and/or one or more bus to couple the devices together.

The processor may include any appropriate processor or processors and can include multiple cores for multi-thread or parallel processing. The storage medium may include memory modules, such as ROM, RAM, and flash memory modules, and mass storages, such as CD-ROM, U-disk, removable hard disk, etc. The storage medium may store computer programs for implementing various processes, when executed by processor.

The peripherals may include I/O devices such as keyboard and mouse, and the communication module may include network devices for establishing connections through a communication network such as a wireless Internet. The database may include one or more databases for storing certain data and for performing certain operations on the stored data, such as webpage browsing, database searching, etc.

The embodiments disclosed herein are examples only. Other applications, advantages, alternations, modifications, or equivalents to the disclosed embodiments are obvious to those skilled in the art.

What is claimed is:

1. A method for operating a list in a handheld device comprising:
monitoring a list and acquiring list touch initial information;
determining whether the acquired list touch initial information is multi-area touch information;
acquiring and storing list touch final information when the acquired list touch initial information is the multi-area touch information;
determining whether a list operation is an expansion operation or a contraction operation, based on the acquired list touch initial information and the list touch final information; and
expanding the list when the expansion operation is determined or collapsing the list when the contraction operation is determined.

2. The method of claim 1, wherein acquiring the list touch final information comprises:
pre-setting an update period for touch information;
monitoring and determining that a finger or a touch pen is not lifted off from a touchscreen of the handheld device; and
acquiring and recording the list touch final information, according to the update period of the touch information.

3. The method of claim 2, wherein, after the acquired list touch initial information is determined to be the multi-area touch information, the method further comprises:
triggering a timer to perform timing, and
performing the operation of acquiring and storing the list touch final information, when a timed time exceeds a pre-set time threshold for long-pressing and a change of a touch area corresponding to the multi-area touch information is within a pre-set change range.

4. The method of claim 1, wherein the multi-area touch information comprises two-finger touch information and comprises list touch initial information of a first touch area and list touch initial information of a second touch area; and wherein the list touch final information comprises list touch final information of the first touch area and list touch final information of the second touch area.

5. The method of claim 4, wherein determining whether the list operation is the expansion operation or the contraction operation comprises:
calculating an initial touch position of the first touch area, based on the acquired list touch initial information of the first touch area,
calculating an initial touch position of the second touch area, based on the acquired list touch initial information of the second touch area; and
respectively calculating a final touch position of the first touch area and a final touch position of the second touch area, based on the acquired list touch final information of the first touch area and the list touch final information of the second touch area,
wherein the list operation is the contraction operation, when a distance between the initial touch position of the first touch area and the initial touch position of the second touch area is greater than a distance between the final touch position of the first touch area and the final touch position of the second touch area; and
wherein the list operation is the expansion operation, when the distance between the initial touch position of the first touch area and the initial touch position of the second touch area is less than the distance between the final touch position of the first touch area and the final touch position of the second touch area.

6. The method of claim 4, wherein the first touch area is a thumb touch area and the second touch area is an index finger touch area, and wherein determining whether the list operation is the expansion operation or the contraction operation comprises:
calculating an initial touch position of the second touch area, based on the acquired list touch initial information of the second touch area; and
calculating a final touch position of the second touch area, based on the acquired list touch final information of the second touch area,
wherein the list operation is the contraction operation, when a distance between the initial touch position of the first touch area and the final touch position of the first touch area is greater than a distance between the initial touch position of the second touch area and the final touch position of the second touch area; and
wherein the list operation is the expansion operation, when the distance between the initial touch position of the first touch area and the final touch position of the first touch area is less than the distance between the initial touch position of the second touch area and the final touch position of the second touch area.

7. The method of claim 4, wherein the first touch area is a thumb touch area, the second touch area is an index finger touch area, and the thumb touch area maintains unchanged, and wherein determining whether the list operation is the expansion operation or the contraction operation comprises:
calculating an initial touch position of the second touch area, based on the acquired list touch initial information of the second touch area; and
calculating a final touch position of the second touch area, based on the acquired list touch final information of the second touch area,
wherein the list operation is the contraction operation, when a difference between a horizontal axis coordinate value of the initial touch position of the second touch area and a horizontal axis coordinate value of the final touch position of the second touch area is greater than zero; and
wherein the list operation is the expansion operation, when the difference between the horizontal axis coordinate value of the initial touch position of the second touch area and the horizontal axis coordinate value of the final touch position of the second touch area is less than zero.

8. The method of claim 4, further comprising:
performing an animation in one or both of the expansion operation and the contraction operation.

9. The method of claim 4, further comprising:
deleting the list touch initial information and the list touch final information.

10. A device for operating a list in a handheld device comprising:
a list touch information acquisition module, a list touch information processing module, and a list processing module, wherein:
the list touch information acquisition module is configured to acquire list touch initial information and list touch final information of a list on a user operating touchscreen, and to output to the list touch information processing module;
the list touch information processing module is configured to determine whether the received list touch initial information is multi-area touch information, and to sequentially output the list touch initial information and the list touch final information to the list processing module, when the received list touch initial information is determined to be the multi-area touch information; and
the list processing module is configured, based on the received list touch initial information and the list touch final information, to determine whether a list operation is an expansion operation or a contraction operation, and to expand the list for the expansion operation or to collapse the list for the contraction operation.

11. The device of claim 10, further comprising a timing module configured to perform timing, after receiving from the list touch information acquisition module a notification about the acquisition of the list touch initial information; and to notify the list touch information acquisition module to acquire the list touch final information of the list on the user operating touchscreen, when a pre-set touch information update period arrives and when it is monitored that the user's fingers are not lifted off from the touchscreen.

12. The device of claim 10, wherein the list processing module further comprises a touch area position calculation unit, a distance calculation unit, and a list processing unit; and wherein
the touch area position calculation unit is configured to respectively calculate initial touch position information of a first touch area and initial touch position information of a second touch area, based on the received list touch initial information; and to respectively calculate final touch position information of the first touch area and final touch position information of the second touch area, based on the received list touch final information; and to output to the distance calculation unit;
the distance calculation unit is configured to calculate an initial relative distance between the initial touch position of the first touch area and the initial touch position of the second touch area, based on the initial touch position information of the first touch area and the initial touch position information of the second touch area; and to calculate a final relative distance between the final touch position of the first touch area and the final touch position of the second touch area, based on the final touch position information of the first touch area and the final touch position information of the second touch area; and to output to the list processing unit; and
the list processing unit is configured to collapse the list when the initial relative distance is greater than the final relative distance and to expand the list when the initial relative distance is less than the final relative distance.

13. The method of claim 2, wherein the multi-area touch information comprises two-finger touch information and comprises list touch initial information of a first touch area and list touch initial information of a second touch area; and wherein the list touch final information comprises list touch final information of the first touch area and list touch final information of the second touch area.

14. The method of claim 13, wherein determining whether the list operation is the expansion operation or the contraction operation comprises:
calculating an initial touch position of the first touch area, based on the acquired list touch initial information of the first touch area,
calculating an initial touch position of the second touch area, based on the acquired list touch initial information of the second touch area; and
respectively calculating a final touch position of the first touch area and a final touch position of the second touch area, based on the acquired list touch final information of the first touch area and the list touch final information of the second touch area,
wherein the list operation is the contraction operation, when a distance between the initial touch position of the first touch area and the initial touch position of the second touch area is greater than a distance between the final touch position of the first touch area and the final touch position of the second touch area; and
wherein the list operation is the expansion operation, when the distance between the initial touch position of the first touch area and the initial touch position of the second touch area is less than the distance between the final touch position of the first touch area and the final touch position of the second touch area.

15. The method of claim 13, wherein the first touch area is a thumb touch area and the second touch area is an index finger touch area, and wherein determining whether the list operation is the expansion operation or the contraction operation comprises:
calculating an initial touch position of the second touch area, based on the acquired list touch initial information of the second touch area; and
calculating a final touch position of the second touch area, based on the acquired list touch final information of the second touch area,
wherein the list operation is the contraction operation, when a distance between the initial touch position of the first touch area and the final touch position of the first touch area is greater than a distance between the initial touch position of the second touch area and the final touch position of the second touch area; and
wherein the list operation is the expansion operation, when the distance between the initial touch position of the first touch area and the final touch position of the first touch area is less than the distance between the initial touch position of the second touch area and the final touch position of the second touch area.

16. The method of claim 13, wherein the first touch area is a thumb touch area, the second touch area is an index finger touch area, and the thumb touch area maintains unchanged, and wherein determining whether the list operation is the expansion operation or the contraction operation comprises:
calculating an initial touch position of the second touch area, based on the acquired list touch initial information of the second touch area; and
calculating a final touch position of the second touch area, based on the acquired list touch final information of the second touch area,
wherein the list operation is the contraction operation, when a difference between a horizontal axis coordinate value of the initial touch position of the second touch area and a horizontal axis coordinate value of the final touch position of the second touch area is greater than zero; and
wherein the list operation is the expansion operation, when the difference between the horizontal axis coordinate value of the initial touch position of the second touch area and the horizontal axis coordinate value of the final touch position of the second touch area is less than zero.

17. The method of claim 13, further comprising:
performing an animation in one or both of the expansion operation and the contraction operation.

18. The method of claim 13, further comprising:
deleting the list touch initial information and the list touch final information.

19. The device of claim 11, wherein the list processing module further comprises a touch area position calculation unit, a distance calculation unit, and a list processing unit; and wherein
the touch area position calculation unit is configured to respectively calculate initial touch position information of a first touch area and initial touch position information of a second touch area, based on the received list touch initial information; and to respectively calculate final touch position information of the first touch area and final touch position information of the second touch area, based on the received list touch final information; and to output to the distance calculation unit;
the distance calculation unit is configured to calculate an initial relative distance between the initial touch position of the first touch area and the initial touch position of the second touch area, based on the initial touch position information of the first touch area and the initial touch position information of the second touch area; and to calculate a final relative distance between the final touch position of the first touch area and the final touch position of the second touch area, based on the final touch position information of the first touch area and the final touch position information of the second touch area; and to output to the list processing unit; and the list processing unit is configured to collapse the list when the initial relative distance is greater than the final relative distance and to expand the list when the initial relative distance is less than the final relative distance.
